(19) United States
(12) Patent Application Publication
(10) Pub. No.: US 2010/0290654 A1
(43) Pub. Date: Nov. 18, 2010

(54) HEURISTIC HEARING AID TUNING SYSTEM AND METHOD

(76) Inventors: Dan Wiggins, Edmonds, WA (US); Donald L. Bowie, Burien, WA (US)

Correspondence Address: AEON LAW, 1525 4TH AVE, STE 800, SEATTLE, WA, 98101-1648, US

(21) Appl. No.: 12/760,444

(22) Filed: Apr. 14, 2010

Related U.S. Application Data
(60) Provisional application No. 61/169,243, filed on Apr. 14, 2009.

(51) Int. Cl. H04R 25/00

(52) U.S. Cl. 381/314

(57) ABSTRACT

A heuristic method of iteratively tuning a hearing aid is provided herein.

### FIELD

The field relates to hearing aids, and more particularly to tuning hearing aids via a heuristic tuning routine.

### BACKGROUND

At some point in their lives, many people may experience a full or partial decrease in their ability to detect or understand some or all sounds, i.e., a hearing impairment. For many such hard of hearing individuals, the degree of hearing impairment varies by sound frequency. For example, many hard of hearing individuals may have little or no impairment at low sound frequencies, but varying degrees of impairment at higher frequencies. Loss of the ability to understand speech is generally regarded as one of the more detrimental aspects of hearing impairment. The frequency range from about 100 Hz-8 kHz is generally regarded as being useful for understanding speech.

In some cases, certain groups of hard of hearing individuals may share certain general characteristics. For example, statistical thresholds of hearing have been developed for men and women of various ages. However, most individuals have a distinct pattern of impairment that may vary from the statistical thresholds. Consequently, devices that are intended to compensate for an individual's personal hearing impairment often perform better when they are matched to the individual's distinct pattern of impairment.

Many hearing aids include one or more adjustable audio-processing circuits and/or routines. For example, hearing aids commonly include one or more equalization filters and/or amplifiers that may be used to selectively boost or cut various portions of the audible frequency spectrum. In addition, many hearing aids also include other adjustable audio-processing circuits and/or routines, such as gain controls, limiters, compressors, and the like. By adjusting a hearing aid's audio-processing parameters, a hearing aid can often be “tuned” to compensate for an individual's distinct pattern of impairment.

At the present time, hearing aids are generally tuned by an auditory healthcare professional, often in a clinical setting. As part of the tuning process, an audiogram (a standardized plot representing the individual's hearing threshold) may be created, generally by performing a “pure tone audiometry” hearing test. Pure tone audiometry hearing tests usually involve presenting pure tones at varying frequencies and levels to an individual wearing calibrated headphones in a sound-controlled environment. The resulting audiogram may provide a starting point for tuning a hearing aid, but it is generally regarded that pure tone audiometry may not accurately measure the full extent of an individual's hearing impairment. For example, pure tone audiometry may not be able to accurately measure the effect of “dead regions” in an individual's basilar membrane. In addition, pure tone audiometry may not measure various factors that are important to speech intelligibility.

Consequently, a further block in tuning a hearing aid generally includes assessing speech intelligibility, often by asking the hearing aid wearer to subjectively evaluate spoken words and/or phrases. Often, the auditory healthcare professional will use his or her own voice as an intelligibility test signal, speaking words or phrases and asking the hearing aid wearer to evaluate the spoken words or phrases. In many cases, the spoken words may include words selected from several pairs of words that differ only by an initial, final, or intervocalic consonant. The auditory healthcare professional may then use the individual's responses to adjust various hearing aid audio-processing parameters.

However, this approach to speech intelligibility tuning may have drawbacks. For example, it may be difficult to achieve consistent results from tuning session to tuning session. In many cases, a hearing aid may need to be tuned multiple times, often over a period of days or weeks, before the wearer finds its performance acceptable. In many cases, the auditory healthcare professional's voice may change slightly or significantly from session to session (e.g., the professional's voice may be altered when he or she has a cold), so it may be difficult compare results from session to session. In other cases, an auditory healthcare professional may retire or move, in which case, subsequent speech intelligibility evaluations may be based on a completely different test signal.

### BRIEF DESCRIPTION OF THE DRAWINGS

FIG. 1 is a system diagram of a calibrated tuning appliance, a host device, and hearing aids in accordance with one embodiment.

FIG. 2 is a block diagram of a calibrated tuning appliance in accordance with one embodiment.

FIG. 3 lists an illustrative set of hearing aid audio tuning parameters in accordance with one embodiment.

FIG. 4 is a flow diagram illustrating a heuristic hearing aid tuning routine in accordance with one embodiment.

FIG. 5 illustrates several exemplary user perception queries in accordance with one embodiment.

FIG. 6 is a diagram illustrating a user perception feedback input graphical user interface, in accordance with one embodiment.

FIG. 7 is a flow diagram illustrating a hearing aid audio parameter adjustment subroutine in accordance with one embodiment.

FIGS. 8-10 are normalized graphs plotting sound pressure level (“SPL”) in decibels (y-axis) versus logarithmic frequency in hertz (x-axis) for various illustrative sets of data utilized by the perception evaluation subroutine of FIG. 7, in accordance with one embodiment.

### DESCRIPTION

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments.

Further, various operations and/or communications may be described as multiple discrete operations and/or communications, in turn, in a manner that may be helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

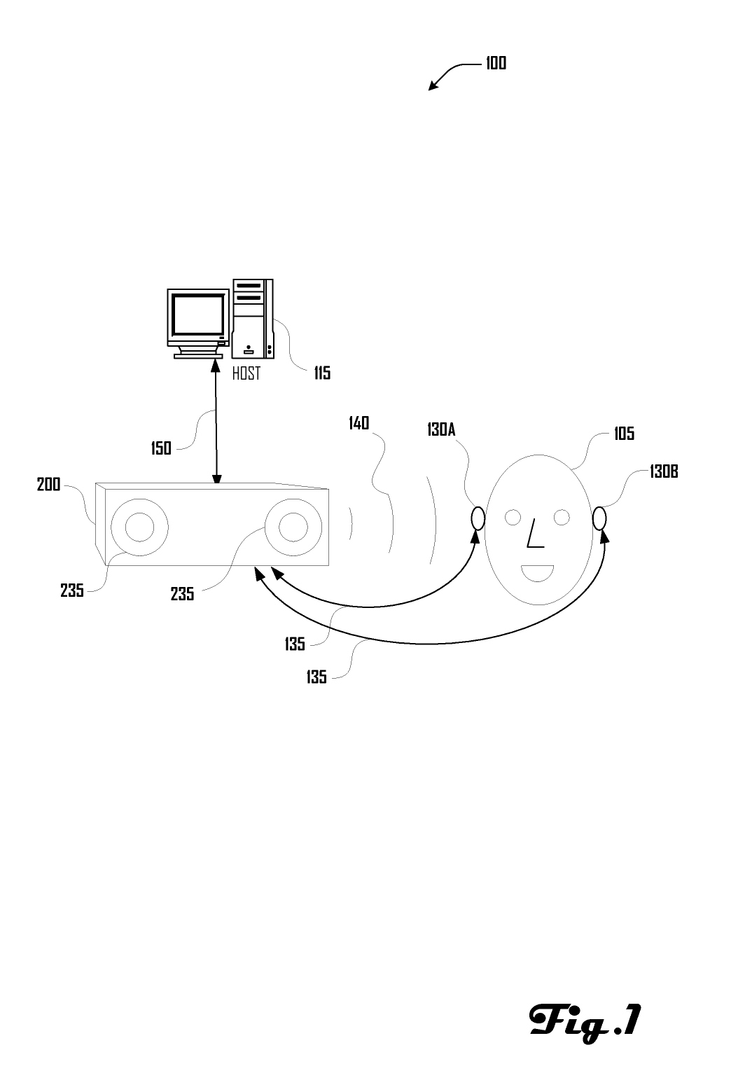

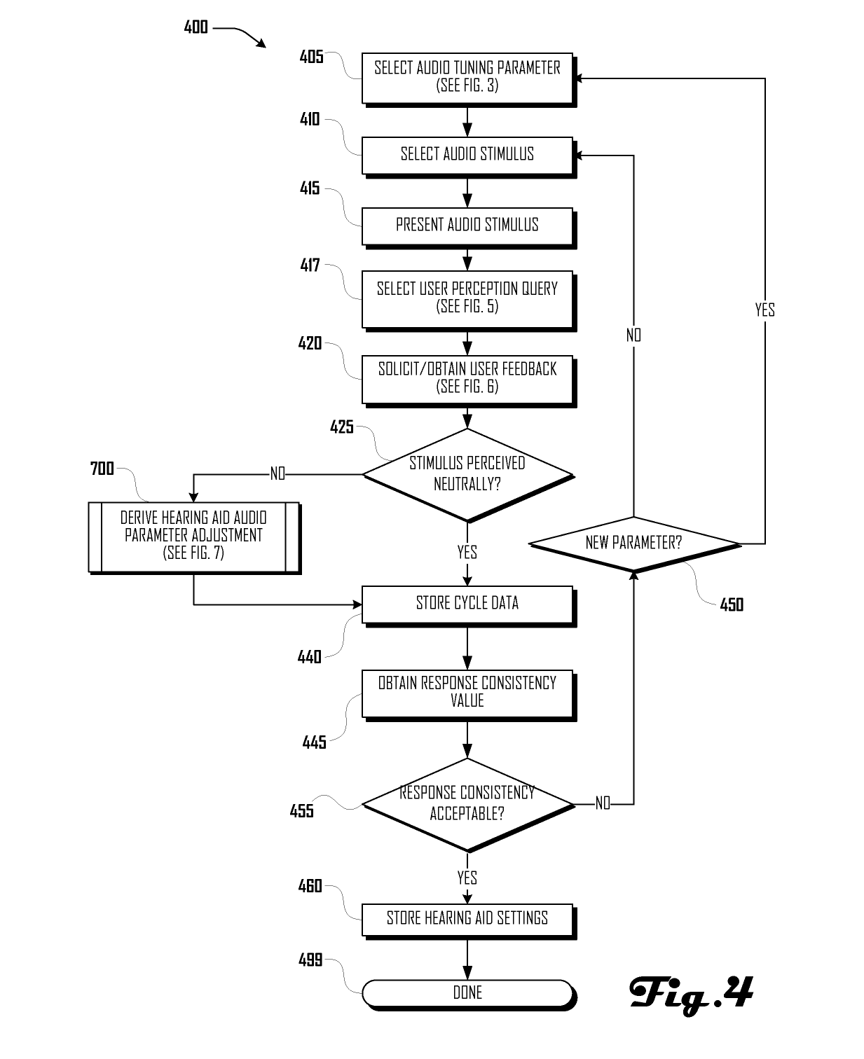

FIG. 1 is a system diagram of a calibrated tuning appliance 200, a host device 115, and hearing aids 130A-B in accordance with one embodiment. Using various embodiments of such a system 100, a hearing aid wearer 105 may be able to tune his or her own hearing aid or hearing aids 130A-B via heuristic tuning routine 400 (see FIG. 4, discussed below) and sound waves 140 produced by calibrated electro-acoustic transducers 235. In one embodiment, calibrated tuning appliance 200 communicates with a host 115, via a host connection 150, and one or more hearing aids 130A-B, via one or more hearing aid connections 135. Although calibrated tuning appliance 200 and its associated tuning routines 400 may be utilized by a hearing aid wearer 105 test their personal hearing levels and/or to tune his or her own hearing aids 130A-B, calibrated tuning appliance 200 may also be utilized by a auditory healthcare professional to provide a consistent tuning experience to one or more hearing aid wearers 105.

In one embodiment, calibrated tuning appliance 200 is coupled to one or more hearing aid earpieces 130A-B via a magnetic-inductive data coupler, as described in co-filed application entitled “MAGNETIC EARPIECE COUPLING SYSTEM,” with inventors Daniel Wiggins and Donald Bowie and having Attorney Docket No. AURA-2009002, which is hereby fully incorporated by reference.

In the exemplary embodiment, calibrated tuning appliance 200 comprises a single enclosure, but in other embodiments, calibrated tuning appliance 200 may comprise one or more separate enclosures. For example, in one embodiment, electro-acoustic transducers 235 may be housed in one or more separate enclosures.

In various embodiments, host 115 may comprise a personal computer, laptop, set top box, mobile device, game console, and/or other computing device having a display capability and user-input capability. In alternate embodiments, calibrated tuning appliance 200 may include its own display and/or input device. In still further embodiments, host 115 may comprise a display and/or an input device, but calibrated tuning appliance 200 may use its own internal processor 210. In some embodiments, calibrated tuning appliance 200 and host 115 may be combined into a single device.

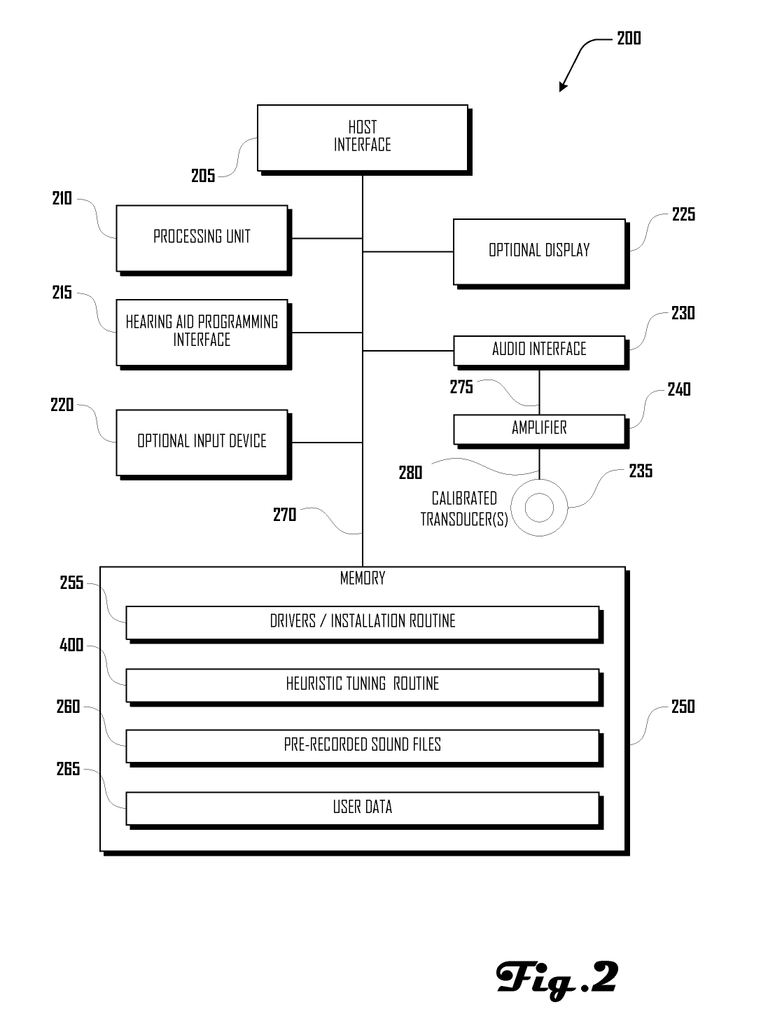

FIG. 2 illustrates a calibrated tuning appliance 200 in accordance with one embodiment. In one embodiment, calibrated tuning appliance 200 includes a host interface 205, processing unit 210, hearing aid programming interface 215, optional input device 220, optional display 225, an audio interface 230, and a memory 250, all connected to a bus 270. In one embodiment, audio interface 230 is further connected via an audio bus 275 to amplification circuitry 240 and via at least one amplified audio bus 280, to one or more calibrated electro-acoustic transducers 235. Calibrated tuning appliance 200 is described in detail in co-pending application entitled “CALIBRATED HEARING AID TUNING APPLIANCE,” with inventors Daniel Wiggins and Donald Bowie, Attorney Docket No. AURA-2009004.

In one embodiment, some or all pre-recorded sound files 260 may be based on standardized sound files used for subjective evaluation of telecommunication systems, such as sound files prepared in accordance with TIA-920 standard promulgated by the U.S. Telecommunications Industry Association (TIA). In some embodiments, pre-recorded sound files 260 may comprise other recordings of speech, including recordings of words, word pairs, phrases, and the like recorded by one or more speakers having determined vocal characteristics (e.g., low male voice, high female voice, and the like). In some embodiments, pre-recorded sound files 260 may further comprise other recorded material, including musical recordings (or excerpts thereof), soundtrack recordings (or excerpts thereof), pure tone recordings, noise recordings (e.g., white noise, pink noise, and other forms of noise having predetermined frequency spectra), and the like.

Memory 250 may also include user data 265. In some embodiments, some or all of memory 250 may be accessible by a user as, for example, a data volume mounted on host 115. In such embodiments, a user may store arbitrary data in memory 250. In other embodiments, a user may not have direct access to memory 250, but heuristic tuning routine 400 may securely store data associated with a user in user data 265. For example, heuristic tuning routine 400 may store in user data 265 user preferences, user hearing aid tuning settings, user hearing aid presets, past user hearing aid tuning settings, and the like. In some embodiments, a user may be able to provide custom-recorded sound files for use with heuristic tuning routine 400, in which case user data 265 may also include one or more custom-recorded sound files. In some such embodiments, calibrated tuning appliance 200 may further comprise a microphone and/or other audio input circuitry.

Many hearing aids provide one or more adjustable audio processing controls (i.e., processing circuits and/or routines) that may be used to tune a hearing aid to compensate for a particular individual's distinct pattern of hearing loss. In various embodiments, a hearing aid may provide gain controls, such as compressor controls, limited controls, and the like, and one or more equalization filters, such as peaking equalization filters; high- and/or low-shelf filters; high-, low-, and/or band-pass filters; allpass filters; notch filters; and the like. In various embodiments, such controls may be implemented as passive and/or active controls; digital and/or analog controls; linear and/or non-linear controls; and the like. Moreover, in some embodiments, a hearing aid may provide one or more additional processing controls such as feedback suppression, noise reduction, and the like.

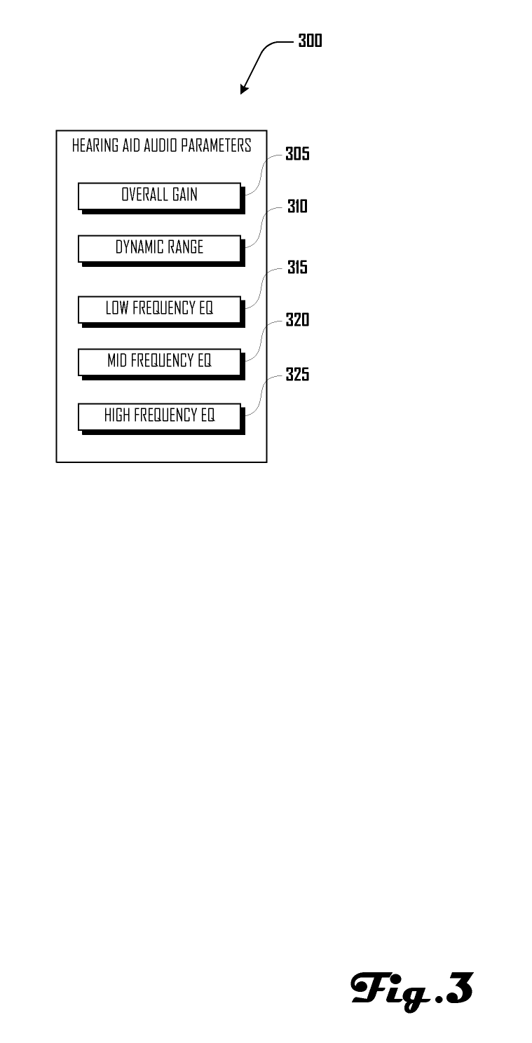

FIG. 3 illustrates an exemplary set of adjustable hearing aid audio parameters 300. In various embodiments, a hearing aid may provide adjustable audio parameters 300 including some or all of the following: overall gain 305, dynamic range 310, low-frequency equalization 315, mid-frequency equalization 320, high-frequency equalization 325, and the like. In other embodiments, more or fewer parameters may be present. In some embodiments, some or all of the adjustable audio parameters 300 may comprise a plurality of adjustable audio sub-parameters. For example, dynamic range parameters 310 may include sub-parameters to control compressor and/or limiter settings such as threshold, attack time, release time, compression ratio, and the like.

Similarly, some or all of low-, mid-, and high-frequency equalization 315-25 parameters may comprise parameters controlling equalization within a plurality of sub-bands. For example, in one embodiment, low-frequency equalization parameters 315 may include gain and/or “Q” (bandwidth) parameters to control equalization filters centered at or near 150 Hz, 240 Hz, and 380 Hz; mid-frequency equalization parameters 320 may include gain and/or “Q” parameters to control equalization filters centered at or near 600 Hz, 950 Hz, and 1500 Hz; and high-frequency equalization parameters 325 may include gain and/or “Q” parameters to control equalization filters centered at or near 2.4 kHz, 3.8 kHz, and 6 kHz. In some embodiments, low-, mid-, and high-frequency equalization 315-25 parameters may also include parameters to control adjustable center frequencies, cutoff frequencies, and the like for equalization filters.

In some embodiments, a hearing aid may provide more or fewer bands of equalization compared to the illustrative embodiments disclosed above. In one embodiment, a hearing aid may provide a selectable number of equalization filters, in which case adjustable hearing aid audio parameters 300 may further include parameters to control the number of equalization filters. Similarly, in some embodiments, a hearing aid may provide a selectable equalization filter type, in which case, adjustable hearing aid audio parameters 300 may further include parameters to control one or more equalization filter types (e.g., high pass, low pass, peaking, shelving, and the like).

FIG. 4 illustrates a heuristic hearing aid tuning routine 400 in accordance with one embodiment. Routine 400 iterates over one or more “tuning cycles” from block 405 to block 455. In some cases, routine 400 could be used, along with pure tone audio stimulus, to prepare an audiogram measuring a user's unaided hearing or hearing loss. However, in most cases, routine 400 is used to present audio stimulus to a user 105 while the user is wearing his or her hearing aids 130A-B, and while the user's hearing aids 130A-B are communicatively coupled to calibrated tuning appliance 200 so that adjustments can be made to the hearing aid settings in accordance with feedback from the user. Further aspects of various embodiments are described in co-pending applications entitled “HEARING AID TUNING METHOD,” with inventors Daniel Wiggins and Donald Bowie, and having Attorney Docket Number AURA-2009003, which is hereby fully incorporated by reference.

Once the user 105 has coupled his or her hearing aids 130A-B to calibrated tuning appliance 200, heuristic tuning routine 400 iteratively proceeds as described below.

In block 405, one or more adjustable audio parameters 300 are selected. The selected parameter or parameters may be adjusted over the course of an iterative tuning cycle. In one embodiment, adjustable audio parameters 300 may be selected first in a pre-determined order, and then once tuning cycles have been performed for each adjustable audio parameter 300, subsequent tuning cycles may chose a specific parameter or even randomly select a tuning parameter. For example, in one embodiment, the first five tuning cycles may select the following respective tuning parameters: overall gain 305, dynamic range 310, low-frequency equalization 315, mid-frequency equalization 320, and high-frequency equalization 325. In other embodiments, a different set of tuning parameters may be selected and/or selected in a different order from that described above. In some embodiments, only the first two tuning cycles may select tuning parameters in a predetermined order (e.g., overall gain 305, dynamic range 310), then the third and subsequent cycles may select tuning parameters randomly or according to other methods such as those discussed below.

In other embodiments, adjustable audio parameters 300 may be selected first in a re-determined order, and then once tuning cycles have been performed for each adjustable audio parameter 300, subsequent tuning cycles may select a tuning parameter based at least in part on data gathered and/or user inputs provided in previous tuning cycles. For example, in one embodiment, tuning parameters for the first two or five tuning cycles may be selected as described above, and tuning parameters for the third or sixth and subsequent cycles may be selected to accord with areas that routine 400 has determined to be sub-optimal. For example, after a number of tuning cycles, a hearing aid wearer may continue to provide inconsistent responses to queries related to, for example, the upper-midrange, indicating that these frequency regions may remain inadequately tuned. In such a case, routine 400 may be more likely to select tuning parameters related to the upper-midrange frequency region.

In still further embodiments, a tuning parameter may be selected using a combination of the methods discussed above (i.e., subsequent parameters selected according to a random weighting based in part on data gathered in previous cycles) and/or using another method of selecting tuning parameters.

In block 410, routine 400 selects an audio stimulus. In one embodiment, an audio stimulus is selected from among pre-recorded sound files 260 stored in memory 250 of calibrated tuning appliance 200. In some embodiments, an audio stimulus is selected randomly from among some or all available audio stimuli. In other embodiments, some or all available audio stimuli are selected in a pre-determined order. In still other embodiments, a list of some or all available audio stimuli is randomly scrambled and the audio stimuli are selected in the order they appear in the scrambled list.

In some embodiments, audio stimuli may be selected based at least in part on the tuning parameter selected in block 405. For example, if the selected tuning parameter relates to a frequency range around 200 Hz-300 Hz, an audio stimulus may be selected to comprise a female voice with a fundamental frequency in the indicated range. Similarly, if the selected tuning parameter relates to a frequency range above 3 kHz-4 kHz, an audio stimulus may be selected to comprise a voice speaking words including sibilant consonants. In other words, in some embodiments, when the tuning parameter selected in block 405 relates to a particular frequency range, in block 410, routine 400 may select an audio stimulus having energy directed to that particular frequency range.

Conversely, in some embodiments, an audio tuning parameter may be selected based at least in part on the selected audio stimulus. (i.e., in some embodiments, block 410 may be performed before block 405, and the selection in block 405 may depend at least in part on the selection in block 410.). For example, an audio stimulus may be selected in block 410 that comprises a voice speaking two words that differ only according to a vowel sound (e.g., “soup” and “soap”), and a tuning parameter may be selected in block 405 that relates to the frequency region where the differences in the two vowel sounds manifest (e.g., around 300-600 Hz for the illustrative vowel sounds).

In block 415, the selected audio stimulus is presented to the user via sound waves 140 propagated through the air. In many embodiments, the selected audio stimulus may be presented via a calibrated audio output chain, such that the sound waves 140 that reach the user 105 have frequency response, sound pressure level, and/or distortion characteristics within predetermined acceptable limits. For example, In one embodiment, sound waves 140 presented to the user 105 may deviate from the selected audio stimulus no more than +/−3 dB in frequency response from 150 Hz-8 kHz at no less than 85-90 dB (SPL) (measured at the user 105) with no more than 3% total harmonic distortion (“THD”). In one embodiment, the selected audio stimulus is presented via audio components 230-40 of calibrated tuning appliance 200.

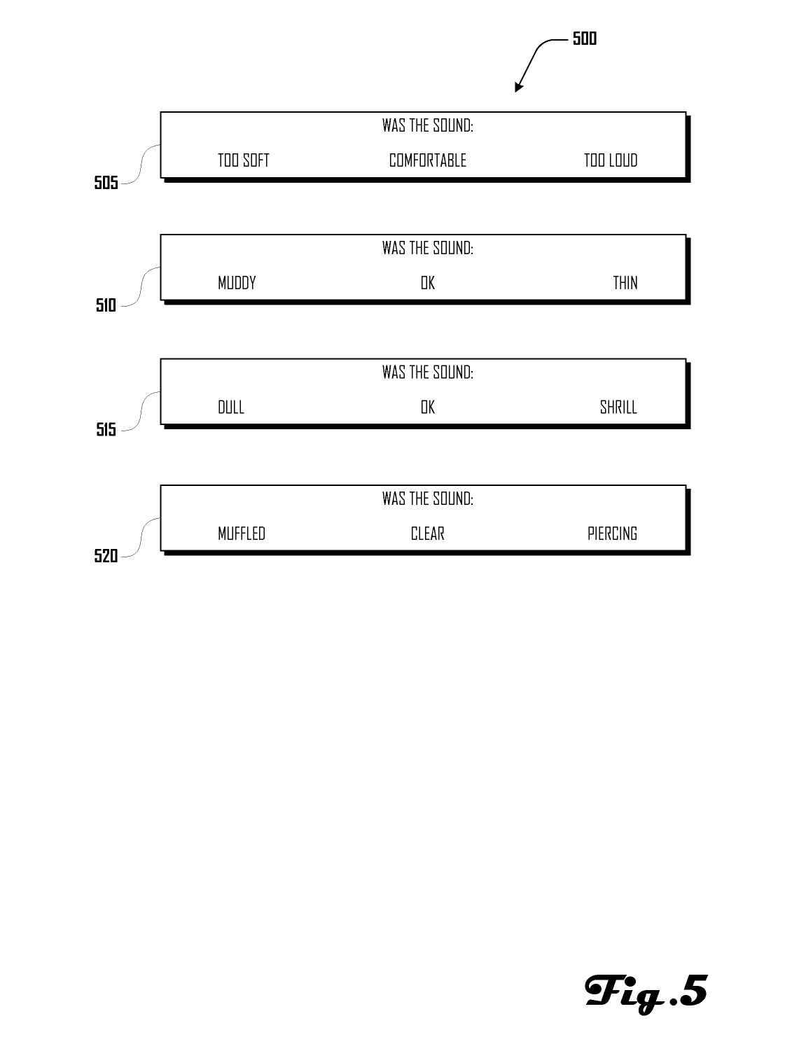

In some embodiments, the selected audio stimulus may optionally be filtered or equalized before being presented. For example, in some cases, routine 400 may purposely boost or cut a particular frequency range of the selected audio stimulus as a consistency check (i.e., routine 400 may induce a “shrill” or “thin” sound to determine whether the user 105 perceives the sound as being “shrill” or “thin,” see FIG. 5 and block 445, discussed below).

In block 417, routine 400 selects a user perception query. In one embodiment, the user perception query is selected from a predetermined list of such queries. In some embodiments, the predetermined list of user perception queries may be derived from standard speech intelligibility tests, such as tests that involve presenting pairs of words that differ only by an initial, final, or intervocalic consonant, or by only a single vowel sound. In such embodiments, the user perception query is likely to be closely tied to the selected audio stimulus and the selected tuning parameter.

In other embodiments, the selected audio stimulus may comprise a 10-15 second long phrase or sentence, and the user perception query may be selected from a predetermined list of questions designed to elicit feedback about the user's subjective perception of sound waves 140 that propagate the selected audio stimulus through the air to the user 105.

In one embodiment, as illustrated in FIG. 5, user perception queries may take the form of “Goldilocks” questions, asking the user whether the audio stimulus he or she just perceived was at one end of a subjective spectrum, neutral, or at the other end of the subjective spectrum (i.e., was the sound “too hot,” “just right,” or “too cold”).

Queries 505-20 illustrate several exemplary “Goldilocks” perception questions. Some embodiments will employ a greater number of queries than are illustrated in FIG. 5. Query 505 (too soft . . . comfortable . . . too loud) may be suitable when the tuning parameter selected in block 405 relates to the user's perception of the sound pressure level of the presented audio stimulus (e.g., overall gain 305, dynamic range 310, and the like). Queries 510-20 may elicit feedback related to the user's perception of the frequency spectrum of the presented audio stimulus, and queries 510-20 the may be suitable when the selected tuning parameter relates to a frequency range. In other embodiments, a user perception query may take other forms, such as asking the user to rate his or her perception of the presented audio stimulus along a range (e.g., 1-5, 1-10, and the like) or as a binary choice (e.g., good or bad).

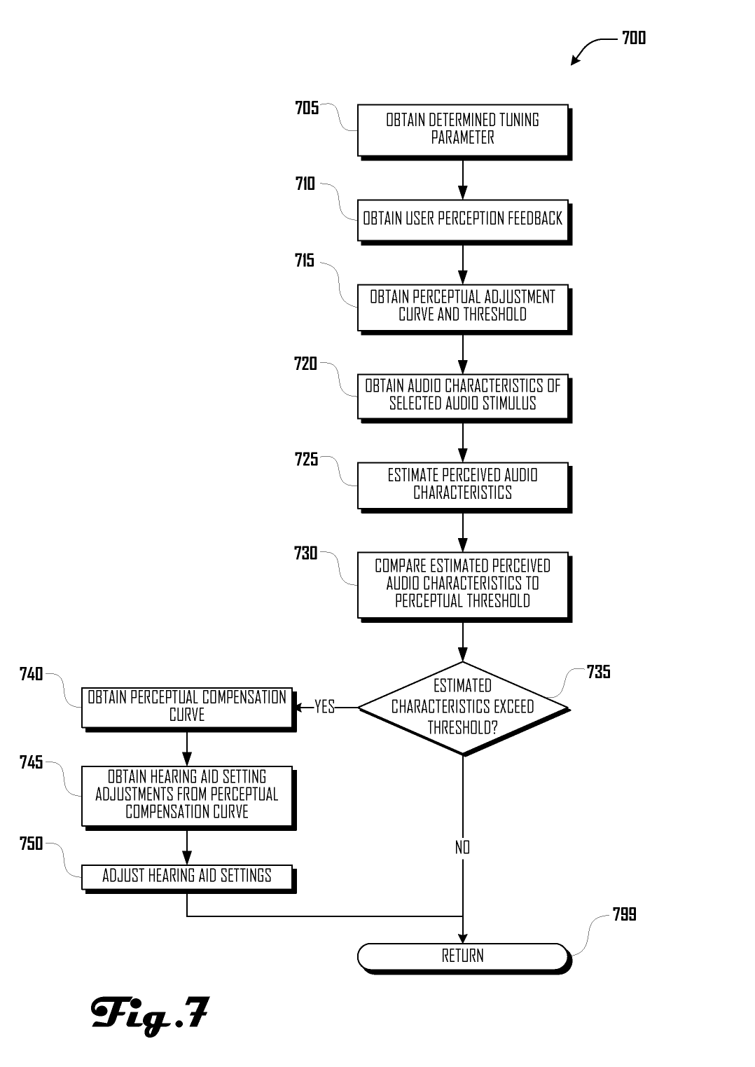

Generally, non-neutral responses to a user perception query may be associated with one or more audio tuning parameters. For example, a “muddy” response may indicate that the user 105 perceives too much energy in the low frequency range or the midrange, depending on the spectral content of the presented audio stimulus (see FIG. 7, discussed below). Conversely, a “thin” response may indicate that the user 105 perceives too little energy in the low- and/or mid-range, again depending on the spectral content of the presented audio stimulus. Similarly, a “shrill” response may indicate that the user 105 perceives too much energy in the high-frequency range. In some cases, different perception queries may overlap to some extent. For example, query 515 and query 520 may generally provide similar clues about the user's perception of the presented audio stimulus. In some embodiments, such redundancy may be desired because different users may associate different spectral imbalances with different terms, and/or different users may have divergent interpretations of the same term.

Referring again to FIG. 4, in block 420, feedback is solicited and obtained from the user 105. In one embodiment, feedback is solicited via a graphical display associated with host 115 and/or calibrated tuning appliance 200, and feedback is obtained via an input device associated with the same.

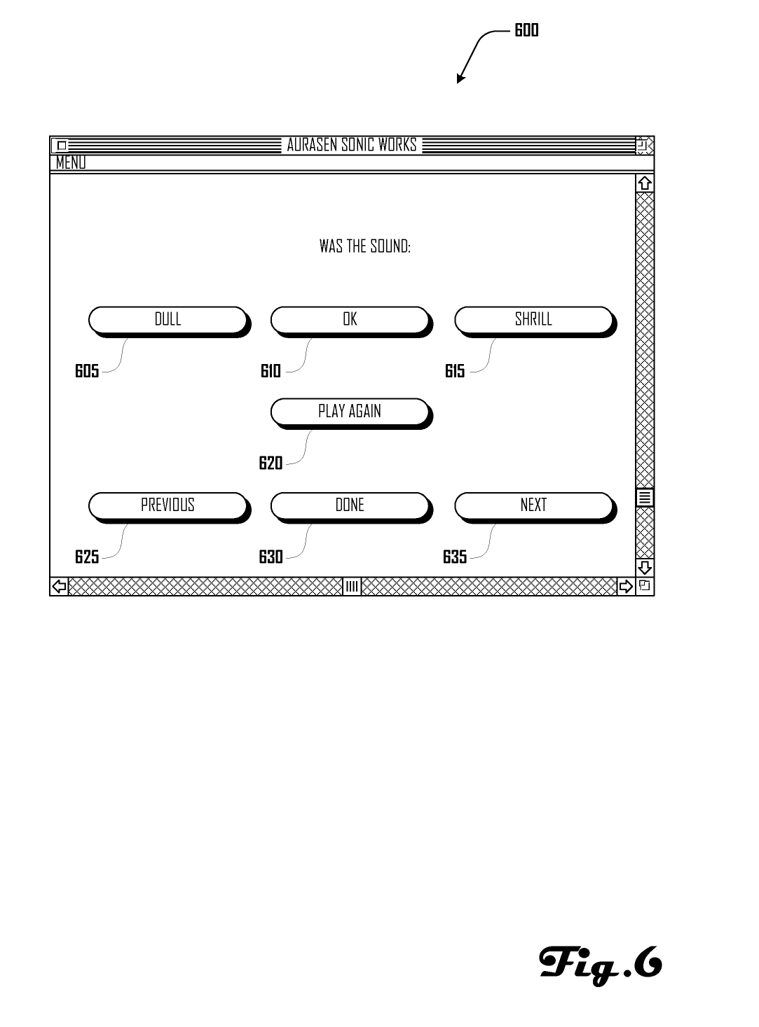

For example, as illustrated in FIG. 6, the selected user perception query may be displayed on a display 600 with graphical user interface (“GUI”) controls provided for the user to provide feedback. For example, in one embodiment, the user may click one of a plurality of buttons 605-15 to provide feedback on his or her subjective perception of the presented audio stimulus. In some embodiments, additional controls, such as some or all of controls 620-35, may also be provided via GUI display 600. In various embodiments, GUI controls may be displayed on a display 225 associated with calibrated tuning appliance 200 and/or host 115. Similarly, in various embodiments, input from the user 105 may be accepted via input device 220 and/or an input device associated with host 115.

Referring again to FIG. 4, in block 425, routine 400 determines whether the user-provided feedback was neutral or “just right” (e.g., “OK” 610). If user feedback was neutral, then the user likely did not perceive an imbalance from the sound he or she perceived. Therefore, in most cases, there is no need to adjust the selected tuning parameter when the user provides neutral feedback, so routine 400 proceeds to block 440, in which some or all of the following data related to the current cycle is stored at least temporarily: the user's feedback, the selected tuning parameter, the selected audio stimulus, current date and/or time, the number of times the user replayed the audio stimulus (if a replay control 620 is offered), the amount of time the user took to provide feedback, and the like.

If decision block 425 determines that the user did not provide neutral feedback in block 420, routine 400 derives one or more hearing aid audio parameter adjustments. In some cases, it may be relatively simple to map the selected user perception query onto an audio parameter adjustment. For example, when the selected audio tuning parameter relates to overall gain, and the user feedback indicates that the presented audio stimulus was “too loud” or “too soft,” then the derived audio parameter adjustment may simply be to lower or raise a gain control by some increment, e.g., −3 dB or +3 dB, respectively. In such a case, routine 400 may translate the determined audio adjustment into one or more programming instructions and program the user's hearing aid(s) 130A-B to conform to the new settings.

In some embodiments, when overall gain is being tuned, a gain adjustment increment may be greater or smaller than 3 dB. In one embodiment, a gain adjustment increment may be relatively large, e.g. 6 dB-12 dB, during early tuning cycles and relatively smaller, e.g. 1 dB-3 dB, during later tuning cycles. In another embodiment, routine 400 may present the user with additional feedback controls that map to different gain adjustment increments. For example, the user may be able to indicate that the presented audio stimulus was “much too loud/soft,” in which case a larger increment (e.g., 6 dB-12 dB) may be used, or merely “slightly too loud/soft,” in which case a smaller increment (e.g., 1 dB-3 dB) may be used

However, in many cases, it may be more difficult to map the selected user perception query onto an audio parameter adjustment. For example, when the selected audio tuning parameter relates to gain adjustments of a particular frequency range, routine 400 may invoke a subroutine such as subroutine 700, illustrated in FIG. 7 and discussed below, in which an adjustment to the selected audio tuning parameter may be derived from the user's feedback as it relates to the presented audio stimulus. Once a hearing aid audio parameter adjustment has been derived, routine 400 proceeds to block 440, as discussed above.

In block 445, routine may obtain a consistency value associated with data stored in block 440. In block 455, the obtained response consistency value is evaluated to determine whether to perform an additional tuning cycle. For example, the stored data may indicate that the user consistently finds presented stimuli to be too shrill, suggesting not only that subsequent tuning cycles may be desirable (i.e., routine 400 should proceed to block 450), but also that subsequent cycles may wish to emphasize high-frequency related tuning parameters. Conversely, the stored data may indicate that the user's responses (or the user's recent responses) generally conform to perceptions that are expected, considering the spectral content of the presented audio stimuli. In such cases, routine 400 may proceed to block 460, in which the user's final hearing aid settings may be persistently stored, along with some or all of the collected tuning cycle data. At block 499, routine 400 ends.

If decision block 455 determines that additional tuning cycles may be needed to improve the user's response consistency, routine 400 proceeds to decision block 450, in which routine 400 determines whether to select a new audio tuning parameter. In one embodiment, routine 400 generally devotes 2-4 tuning cycles to the same tuning parameter before selecting a new tuning parameter. In other embodiments, routine may determine whether to choose a new tuning parameter based at least in past on whether the user has recently provided consistent responses to the current tuning parameter. If a new audio tuning parameter is to be selected (in decision block 450), routine 400 iterates to block 405, where a new tuning cycle begins. If not, routine 400 iterates to block 410, where a new tuning cycle begins.

FIG. 7 illustrates an exemplary hearing aid frequency-related audio parameter adjustment subroutine 700 in accordance with one embodiment. In block 705, routine 700 obtains a determined tuning parameter, such as the tuning parameter selected in block 405 of hearing aid tuning routine 400. In one embodiment, the determined audio tuning parameter may be associated with a frequency range. Similarly, in block 710, subroutine 700 obtains a user perception feedback, such as that obtained in block 420 of hearing aid tuning routine 400.

In block 715, subroutine 700 obtains a perceptual adjustment curve and threshold in accordance with the obtained user perception feedback. In some embodiments, perceptual thresholds may be weighted according to a subjective equal-loudness curve, such as A-weighting curves, C-weighting curves, Fletcher-Munson curves, Robinson-Dadson curves, and the like.

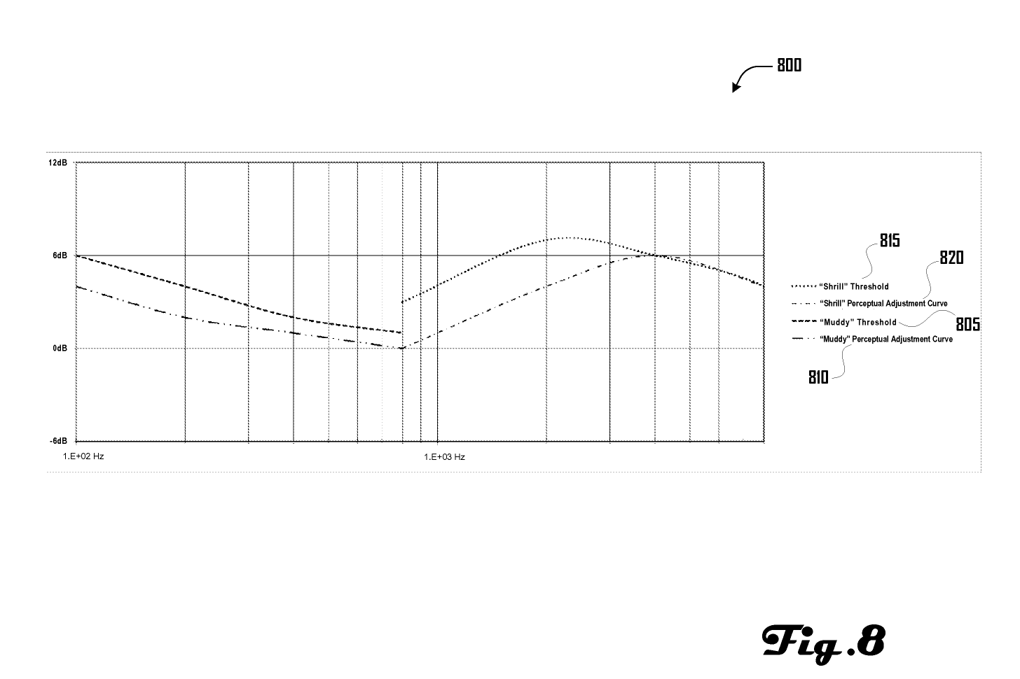

FIGS. 8-10 plot sound pressure level (“SPL”) in decibels (y-axis) versus logarithmic frequency in hertz (x-axis) for various illustrative sets of data utilized by the perception evaluation subroutine of FIG. 7, in accordance with one embodiment

FIG. 8 illustrates two exemplary sets of perceptual adjustment curves and thresholds. In various embodiments, a perceptual threshold, such as “Shrill” threshold 815 and “Muddy” threshold 805, may be used to determine at least in part whether to adjust a hearing aid setting in response to a particular user feedback for a particular presented audio stimulus. If a perceptual threshold determines that an adjustment is warranted, in various embodiments, a perceptual adjustment curve may be used to determine an appropriate audio parameter adjustment to make in response to a particular user feedback for a particular presented audio stimulus.

“Shrill” threshold 815 and “Muddy” threshold 805, like all lines of data depicted in FIGS. 8-10, are presented merely as aids to more clearly illustrate the concepts described herein—they do not necessarily represent actual data that may be employed in any particular embodiment, and they should not be construed to limit the scope of embodiments beyond the illustrative embodiments described below. Similarly, in some embodiments, the continuous lines of data depicted in FIGS. 8-10 may represent discrete data points that have been smoothly connected merely for illustrative purposes.

In one embodiment, a perceptual threshold comprises one or more frequency-specific or frequency-range-specific sound pressure level (“SPL”) values. For example, the illustrative “Shrill” threshold 815 comprises a set of SPL values ranging from about 3 dB around 800 Hz, to about 7 dB around 2 kHz, to around 4 dB around 8 kHz. Similarly, “Muddy” threshold 805 comprises SPL values ranging from about 6 dB around 100 Hz, to about 2 dB around 800 Hz. For clarity, the illustrative thresholds 805, 815 (as well as frequency response (“FR”) curves 905, 915, and 1010) are depicted with SPL values relative to an arbitrary 0 dB reference. In various embodiments, actual perceptual thresholds (and frequency response curves) may be relative to an objective 0 dB reference, such as 20 μPa (rms), or other standardized normal human hearing threshold.

Similarly, in various embodiments, perceptual adjustment curves may comprise one or more frequency-specific or frequency-range-specific adjustment values. For example, the illustrated “Shrill” perceptual adjustment curve 820 comprises adjustment values ranging from about 0 dB around 800 Hz, to about +6 dB around 4 kHz, to about +4 dB around 8 kHz. Similarly, the illustrative “Muddy” perceptual adjustment curve 810 ranges from about +4 dB around 100 Hz, to about 0 dB around 800 Hz. In various embodiments, as discussed further below, perceptual adjustment curves may be used to estimate the user's likely perception of a particular audio stimulus based on the user's feedback about that particular audio stimulus.

Referring again to FIG. 7, in block 720, subroutine 700 obtains audio characteristics of the selected audio stimulus. In various embodiments, such audio characteristics may comprise one or more frequency-specific or frequency-range-specific SPL values. In some embodiments, such audio characteristics may have been pre-determined and at least temporarily stored in an accessible memory. In other embodiments, such audio characteristics may be determined “on the fly,” as needed. In some embodiments, such audio characteristics may be “normalized” to an arbitrary reference; in other embodiments, they may be relative to an objective measure of sound pressure. In some embodiments, such audio characteristics may be weighted according to a subjective equal-loudness curve, such as A-weighting curves, C-weighting curves, Fletcher-Munson curves, Robinson-Dadson curves, and the like.

In various embodiments, determining audio characteristics may include transforming audio data of an audio stimulus from the time domain into the frequency domain, according to any suitable method, and measuring the amount of energy present in one or more frequency bins. In other embodiments, determining audio characteristics may include passing an audio stimulus through a plurality of tuned resonant filters and measuring the amplitudes of the outputs of the plurality of resonant filters. In still other embodiments, determining audio characteristics may include analyzing an audio stimulus according to other methods, such as Linear Predictive Coding (“LPC”) and the like.

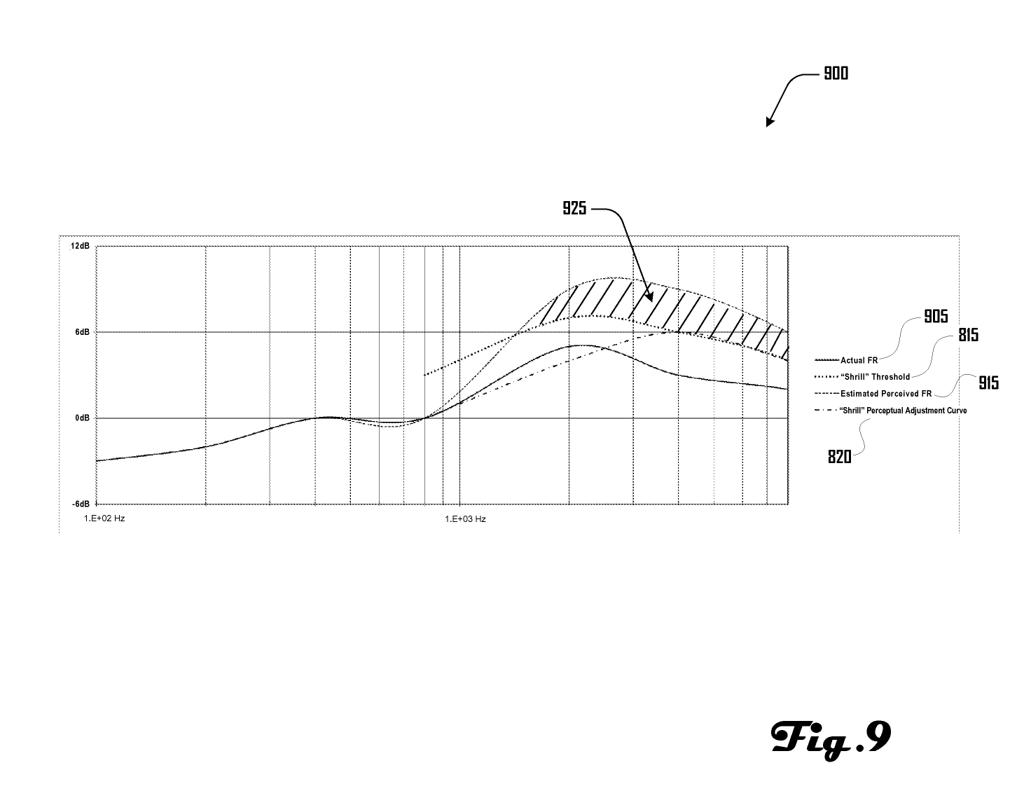

FIG. 9 depicts in line 905 (labeled “Actual FR”) an illustrative set of audio characteristics of a hypothetical audio stimulus relative to an arbitrary 0 dB reference. As illustrated by audio characteristics line 905, the hypothetical audio stimulus includes relatively more energy above 1 kHz than below 1 Hz.

Referring again to FIG. 7, in block 725, subroutine 700 modifies the audio characteristics obtained in block 720 according to the perceptual adjustment curve obtained in block 715. The resulting modified audio characteristics may estimate the user's perception of the presented audio stimulus. For example, in the scenario depicted in FIG. 9, the user provided feedback indicating that the presented audio stimulus was “Shrill.” Line 915 in FIG. 9 (labeled “Estimated Perceived FR”) depicts the Actual FR 905 of the presented audio stimulus modified by the “Shrill” perceptual adjustment curve 820. Line 915 thus represents subroutine 700's estimate of the user's perception of the presented audio stimulus, as suggested by the user's feedback.

Referring again to FIG. 7, in block 730, subroutine 700 compares the estimated perceived audio characteristics (e.g., Estimated Perceived FR 915) to the perceptual threshold obtained in block 715 (e.g., “Shrill” Threshold 815). In decision block 735, subroutine 700 determines whether all or part of the estimated perceived audio characteristics (e.g., Estimated Perceived FR 915) exceeds the perceptual threshold (e.g., “Shrill” Threshold 815). For example, as illustrated in FIG. 9, shaded region 925 depicts that Estimated Perceived FR 915 exceeds “Shrill” Threshold 815 from around 1.5 kHz up to at least 8 kHz.

Referring again to FIG. 7, if decision block 735 determines that the estimated audio characteristics do not exceed the perception threshold, then the subroutine may proceed to return block 799 without adjusting the user's hearing aid settings. However, if decision block 735 determines that the estimated audio characteristics exceed the perception threshold, then the user's hearing aid settings may be adjusted in blocks 740-50, as discussed below.

Thus, in various embodiments, perceptual threshold curves may be used as a sort of “sanity test” to evaluate whether a particular user feedback provides meaningful information about the user's perception of a particular presented audio stimulus. For example, in some cases, the selected audio tuning parameter may relate to a high-frequency region, and a user may provide feedback that he or she perceived a particular audio stimulus as “shrill,” feedback that generally indicates that the user is perceiving too much energy in one or more high-frequency regions. However, if the energy in the upper frequency ranges of that particular audio stimulus is below a “Shrill” perception threshold (not shown), then it may be unlikely that adjusting a high-frequency filter in the user's hearing aid would improve the user's perception. Accordingly, in some embodiments, the user's hearing aid(s) 130A-B may not be adjusted in the current tuning cycle.

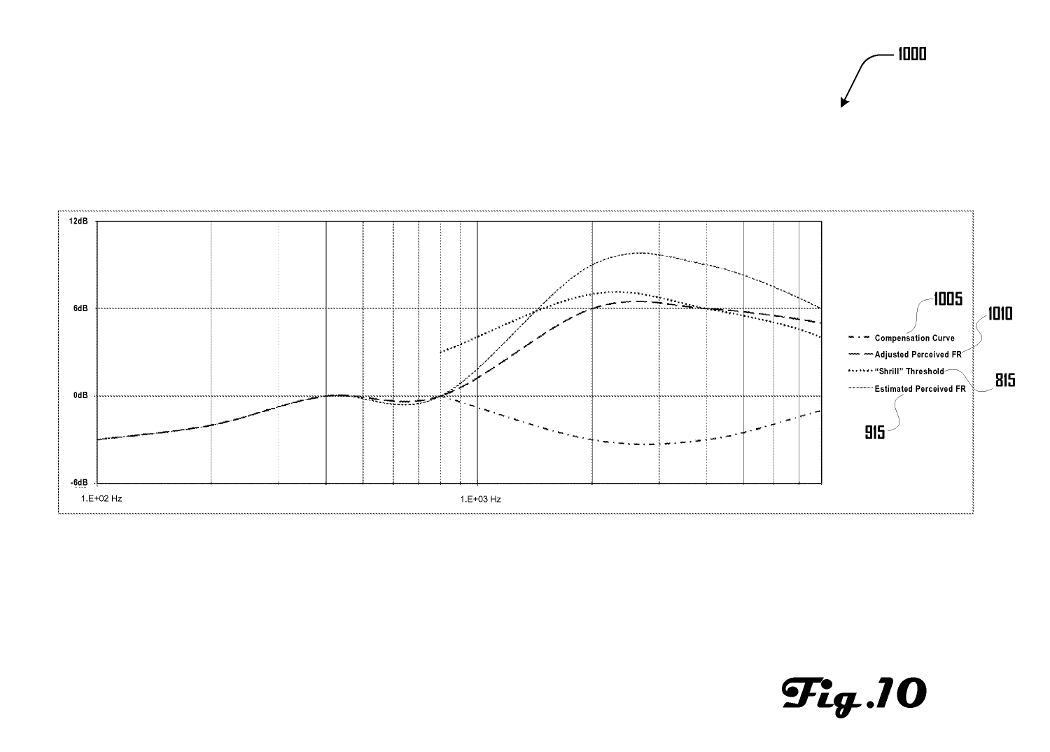

If decision block 735 determines that the estimated audio characteristics exceed the perception threshold, routine 700 proceeds to block 740, which obtains a perceptual compensation curve associated with the selected user perception feedback. An illustrative perceptual compensation curve associated with “Shrill” feedback is depicted by line 1005 in FIG. 10, labeled “Compensation Curve.” In various embodiments, perceptual compensation curves may comprise one or more frequency-specific or frequency-range-specific compensation values. For example, the illustrated “Shrill” perceptual compensation curve 1005 comprises compensation values ranging from about 0 dB around 800 Hz, to about −3 dB around 3 kHz, to about −1 dB around 8 kHz.

Referring again to FIG. 7, in block 745, routine 700 obtains one or more hearing aid setting adjustments in accordance with the obtained perceptual compensation curve and with the determined tuning parameter or parameters obtained in block 705. For example, referring to FIG. 10, the illustrative compensation curve 1005 may indicate that the gain of a hearing aid peaking filter centered around about 3 kHz should be reduced by around 3 dB, which the gain of a hearing aid filter centered around about 6 kHz should be reduced by about 2 dB. Similarly, if a determined tuning parameter is associated with a high-shelf filter, the illustrative compensation curve 1005 may indicate that the gain of a hearing aid high-shelf filter should be reduced by around 1-3 dB, depending on the filter's cutoff frequency.

In some embodiments, the obtained perceptual compensation curve may be used not only to determine a gain adjustment for a hearing aid filter, but it may also be used to determine other parameter settings for one or more hearing aid filters. For example, in one embodiment, compensation curve 1005 may indicate that the user's hearing aid(s) 130A-B may be programmed to implement a low-Q peaking filter (e.g., having a bandwidth of 2-3 octaves) centered at around 3 kHz with a gain of around −3 dB.

Referring again to FIG. 7, in block 750, routine 700 sends programming instructions to the user's hearing aid(s) 130A-B in accordance with the obtained compensation adjustments. Line 1010 in FIG. 10 depicts an estimate of how the user 105 may perceive the audio stimulus after the hearing aid implements the programming instructions. Line 1010 depicts that the user's estimated perception may still exceed the “Shrill” threshold 815 above around 4 kHz. However, in many embodiments, subroutine 700 does not attempt to completely compensate for any particular perception anomaly. Rather, due to the iterative nature of hearing aid tuning routine 400, the compensation adjustments made during any one tuning cycle may make only a relatively modest adjustment to the hearing aid's audio control settings. However, over several tuning cycle iterations, a user's hearing aid(s) 130A-B may become increasingly effective at compensating for the user's particular pattern of hearing loss.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein including the possibility of different adjustments to each hearing aid where more than one hearing aid is utilized.

1. A heuristic method of iteratively tuning a hearing aid as shown and described.
